(19) United States
(12) Patent Application Publication
(10) Pub. No.: US 2016/0024302 A1
(43) Pub. Date: Jan. 28, 2016

(54) POLYCARBONATE BLEND WITH LOW SMOKE GENERATION

(71) Applicants: BAYER MATERIALSCIENCE LLC, Pittsburgh, PA (US); Covestro LLC, Pittsburg, PA (US)

(72) Inventor: Xiangyang Li, Seven Fields, PA (US)

(73) Assignee: Covestro LLC, Pittsburg, PA (US)

(21) Appl. No.: 14/773,849

(22) PCT Filed: Mar. 5, 2014
(86) PCT No.: PCT/US14/20520

§ 371 Date: Sep. 9, 2015

Related U.S. Application Data
(60) Provisional application No. 61/776,954, filed on Mar. 12, 2013.

(51) Int. Cl. C08L 69/00

(52) U.S. Cl. CPC C08L 69/005; C08L 2205/035; C08L 2207/04; C08L 2207/53; C08L 2201/02

(57) ABSTRACT

The present invention provides a polycarbonate composition which contains polycarbonate, a thermoplastic polyester, a graft copolymer, polylactic acid. The inventive composition exhibits low smoke generation.

### CROSS REFERENCE TO RELATED APPLICATION

This application claims the benefit, under 35 USC §119(c), of U.S. provisional patent application No. 61/776,954, filed Mar. 12, 2013, entitled “POLYCARBONATE BLEND WITH LOW SMOKE GENERATION,” the entire disclosure of which is hereby incorporated by reference.

### FIELD OF THE INVENTION

The present invention relates in general to plastics and more specifically to polycarbonate blend with low smoke generation.

### BACKGROUND OF THE INVENTION

U.S. Pat. No. 4,888,388, issued to Hongo et al., discloses an impact resistant composition containing polycarbonate, polyethylene terephthalate and graft polymer based on a silicone-butyl acrylate composite rubber.

Wittmann et al., in U.S. Pat. No. 5,030,675, provide flame-resistant molding compounds of polycarbonate, polyalkylene terephthalate, graft polymer, fluorinated polyolefine and phosphorus compound which can be worked up into molded products and which have a particularly advantageous combination of joint line strength, dimensional stability under heat and toughness.

U.S. Pat. No. 5,871,570, issued to Koyama et al., describes a flame-retardant resin composition comprising the following components (A), (B), (C), (D), (E) and (F), wherein 1-10 parts by weight of (C), 2-10 parts by weight of (D), 0.05-2 parts by weight of (E) and 0.01-10 parts by weight of (F) are contained per 100 parts by weight of a resin whose weight ratio of (A)/(B) is 75/25-90/10. (A) a polycarbonate resin whose viscosity-average molecular weight is 16,000-29,000, (B) a polyalkylene terephthalate resin, (C) a copolymer containing a rubbery polymer and at least one selected from the group consisting of aromatic vinyl monomers, vinyl cyanide monomers, acrylic acid, acrylic esters, methacrylic acid, methacrylic esters and maleimide-type monomers as components, (D) an organic phosphorus-type flame-retardant, (E) a fluorocarbon-type resin, and (F) an epoxy compound not containing halogens. The flame-retardant resin composition is halogen-free and said to possess well-balanced properties of flame retardancy, impact strength, heat resistance, moldability, chemical resistance and heat-induced discoloration resistance, and improved in silver streaks formation.

Matsumoto et al., in U.S. Pat. No. 6,174,943, disclose a flame-retardant thermoplastic resin composition comprising (R) a thermoplastic resin comprising (A) a polycarbonate resin and (B) an aromatic polyester resin in an (A)/(B) ratio of 99/1 to 50/50 by weight, and per 100 parts by weight of the thermoplastic resin (R), (C) 0.5 to 100 parts by weight of a silicate compound and (D) 0.5 to 30 parts by weight of an organic phosphorus based flame retarder. The composition is said to exhibit excellent flame resistance and anti-drip property without containing a halogen atom and, moreover, have excellent properties such as heat resistance, mechanical strength, solvent resistance, surface property of moldings, and dimensional stability.

U.S. Pat. No. 6,329,451, issued to Matsumoto et al., describes a flame-retardant thermoplastic resin composition having incorporated therein a trace of stabilized red phosphorus, which achieves both improvement of heat resistance and flame retardation without using chlorine nor bromine and also possesses long-term heat stability and smells little. The composition comprises (A) 50 to 95 parts by weight of a polycarbonate resin and (B) 5 to 50 parts by weight of a thermoplastic polyester resin, contains (C) 0.1 to 5 parts by weight, per 100 parts by weight of the total amount of (A) and (B), of coated stabilized red phosphorus and preferably contains (D) 0.1 to 100 parts by weight, per 100 parts by weight of the total amount of (A) and (B), of a silicate compound.

WO 94/11429 in the name of Ogoe et al., discloses a blended composition containing polycarbonate; polyester, an acrylate polymer, and/or a styrenic thermoplastic resin; poly(tetrafluoroethylene); an acid acceptor; and a halogenated aryl phosphate; and optionally a halogenated aromatic carbonate oligomer, which composition possesses a desirable balance of ignition resistance, impact resistance and solvent resistance properties.

Urabe et al., in JP 04-345657, provide a flame retardant, chemically resistant and thermally stable composition containing a halogenated aromatic polycarbonate resin, aromatic polyester resin, and graft rubber polymer composite. The graft rubber is said to be obtained by grafting vinyl monomer(s) onto rubber particles consisting of a poly-organosiloxane rubber and a polyalkyl(meth)acrylate rubber entangled with each other so as not to be separated from each other.

Li et al., in U.S. Patent Application Publication No. 2008-0090961, provide a thermoplastic molding composition characterized by its flame retardance and impact strength. The composition contains A) 70 to 99 parts by weight of aromatic poly(ester)carbonate B) 1 to 30 parts by weight of polyalkylene terephthalate, the total weight of A) and B) being 100 parts resin, and C) 1 to 20 parts per hundred parts resin (phr) of graft (co)polymer having a core-shell morphology, including a grafted shell that contains polymerized alkyl(meth)acrylate and a composite rubber core that contains interpenetrated and inseparable polyorganosiloxane and poly(meth)alkyl acrylate components, D) 2 to 20 phr of a phosphorous-containing compound, and E) 0.1 to 2 part by weight of fluorinated polyolefin.

JP 06-239965 in the name of Urabe et al., describes a resin composition composed of (A) 50-90 wt. % of an aromatic polycarbonate resin (preferably derived from bisphenol A), (B) 2-45 wt. % of an aromatic polyester resin. (e.g. polyethylene terephthalate) and (C) 3-25 wt. % of a halogenated bisphenol epoxy resin of the formula

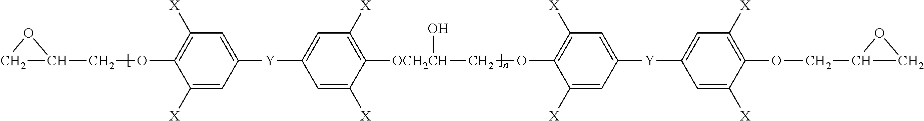

(X is Cl or Br; Y is alkylene, O, etc.; (n) is average polymerization degree and is 21-50). The component C is said to be produced by condensing a halogenated bisphenol such as dibromobisphenol A with epichlorohydrin.

JP 08-073692 in the name of Koyama et al., provides a composition obtained by blending (A) 100 pts. wt. of a resin prepared by mixing (i) a PC resin having 16,000-29,000 viscosity-average molecular weight with (ii) a polyalkylene terephthalate resin in the weight ratio of the component (i)/(ii) of 75/25 to 90/10 with (B) 1-10 pts. wt. of a copolymer containing a rubber-based copolymer and (ii) one or more selected from an aromatic vinyl monomer, a vinyl cyanide, a (meth)acrylic acid (ester) and a maleimide-based monomer as constituent components, (C) 2-10 pts. wt. of an organic phosphorus-based flame-retardant preferably composed of a condensed phosphoric ester of the formula

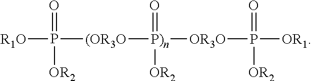

wherein R₁ and R₂ are each a monofunctional aromatic group or aliphatic group; R₃ is a bifunctional aromatic group; n is 0-15 and (D) 0.05-2 pts. wt. of a fluoro-based resin.

JP 2000-001603, in the name of Mizukami et al., describes a polyester composition prepared by incorporating (A) polyethylene terephthalate or its modified product with (B) 1-20 polyester and/or polyether-based block copolymer consisting of hard segments and soft ones, and has <3% crystallinity after heat-treated at 110° C. for 5 min. It is preferred that the hard segment of the block-copolymer is ethylene terephthalate and/or butylene terephthalate, and has 80-97 mol. % content, and that the soft segment of the block-copolymer is polybutylene glycol. The intrinsic viscosity of polyethylene terephthalate is preferably 0.63-0.95.

Yabuhara et al., in JP 2000-026741, describe a composition obtained by including (A) 100 pts. wt. of a thermoplastic resin other than thermotropic liquid crystal polymers (pref. an aromatic polycarbonate/acrylonitrile-butadiene-styrene resin), (B) 0.01-50 pts. wt. of a thermotropic liquid crystal polymer (pref. a polyester-based polymer made from a dicarboxy compound such as terephthalic acid and a dihydroxy compound such as ethylene glycol or hydroquinone), and (C) 1-30 pts. wt. of a halogen element-free phosphazene compound.

Ono et al., in JP 2001-031860, disclose a high impact strength composition said to be hydrolytically stable and chemically resistant. The composition contains polycarbonate, a mixture of polyethylene terephthalate and polybutylene terephthalate, a graft elastomer having a core-shell structure, a silicate salt, stabilized red phosphorus and polytetrafluoroethylene.

U.S. Pat. No. 8,217,101 issued to Li, describes a thermoplastic molding composition characterized by its flame retardance. The composition contains A) aromatic poly(ester)carbonate having a weight-average molecular weight of at least 25,000, B) (co)polyester and C) graft (co)polymer having a core-shell morphology, comprising a grafted shell that contains polymerized alkyl(meth)acrylate and a composite rubber core that contains interpenetrated and inseparable polyorganosiloxane and poly(meth)alkyl acrylate where the weight ratio of polyorganosiloxane/poly(meth)alkylacrylate/grafted shell is 70-90/5-15/5-15, D) phosphorus-containing compound, E) fluorinated polyolefin and F) boron compound having average particle diameter of 2 to 10 μm.

### SUMMARY OF THE INVENTION

Accordingly, the present invention provides a polycarbonate composition which contains polycarbonate, a thermoplastic polyester, a graft copolymer, polylactic acid and a borate compound. The inventive composition exhibits low smoke generation. These and other advantages and benefits of the present invention will be apparent from the Detailed Description or the Invention herein below.

### DETAILED DESCRIPTION OF THE INVENTION

The present invention will now be described for purposes of illustration and not limitation. Except in the operating examples, or where otherwise indicated, all numbers expressing quantities, percentages, functionalities and so forth in the specification are to be understood as being modified in all instances by the term “about.” Equivalent weights and molecular weights given herein in Daltons (Da) are number average equivalent weights and number average molecular weights respectively, unless indicated otherwise.

The present invention provides a thermoplastic molding composition comprising, A) 50 to 98 parts by weight (pbw) aromatic poly(ester)carbonate having a weight-average molecular weight of at least 25,000; B) 1 to 30 parts by weight of thermoplastic polyester; C) 1 to 20 parts per hundred parts resin (phr) of graft (co)polymer having a core-shell morphology, including a grafted shell that contains polymerized alkyl(meth)acrylate and a composite rubber core that contains interpenetrated and inseparable polyorganosiloxane and poly(meth)alkyl acrylate components, wherein said core is in the form of particles having median particle size of 0.05 to 5 microns and glass transition temperature below 0° C., and wherein weight ratio of polyorganosiloxane/poly(meth)alkylacrylate/rigid shell is 70-90/5-15/5-15; and D) 1 to 30 parts by weight of polylactic acid.

### A. Polycarbonate

The term polycarbonate as used in the context of the present invention refers to homopolycarbonates and copolycarbonates (including polyestercarbonates).

Polycarbonates are known and their structure and methods of preparation have been disclosed, for example, in U.S. Pat. Nos. 3,030,331; 3,169,121; 3,395,119; 3,729,447; 4,255,556; 4,260,731; 4,369,303; 4,714,746; and 6,306,507; all of which are incorporated by reference herein. The polycarbonates preferably have a weight average molecular weight of 10,000 to 200,000, more preferably 20,000 to 80,000 and their melt flow rate, per ASTM D-1238 at 300° C., is 1 to 65 g/10 min., preferably 2 to 35 g/10 min. They may be prepared, for example, by the known diphasic interface process from a carbonic acid derivative such as phosgene and dihydroxy compounds by polycondensation (See, German Offenlegungsschriften 2,063,050; 2,063,052; 1,570,703; 2,211,956; 2,211,957 and 2,248,817; French Patent 1,561,518; and the monograph by H. Schnell, “Chemistry and Physics of Polycarbonates”, Interscience Publishers, New York, N.Y., 1964).

In the present context, dihydroxy compounds suitable for the preparation of the polycarbonates of the invention conform to the structural formulae (1) or (2).

wherein,

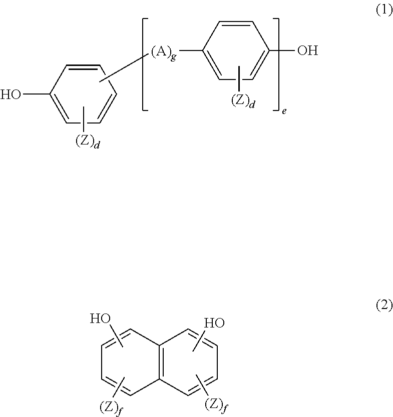

A denotes an alkylene group with 1 to 8 carbon atoms, an alkylidene group with 2 to 8 carbon atoms, a cycloalkylene group with 5 to 15 carbon atoms, a cycloalkylidene group with 5 to 15 carbon atoms, a single bond, a carbonyl group, an oxygen atom, a sulfur atom, —SO— or —SO₂ or a radical conforming to

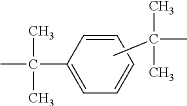

e and g both denote the number 0 to 1;
Z denotes F, Cl, Br or C₁-C₄-alkyl and if several Z radicals are substituents in one aryl radical, they may be identical or different from one another;
d denotes an integer of from 0 to 4; and
f denotes an integer of from 0 to 3.

Among the dihydroxy compounds useful in the practice of the invention are hydroquinone, resorcinol, bis-(hydroxyphenyl)-alkanes, bis-(hydroxyphenyl)-ethers, bis-(hydroxyphenyl)-ketones, bis-(hydroxy-phenyl)-sulfoxides, bis-(hydroxyphenyl)-sulfides, bis-(hydroxyphenyl)-sulfones, and α,α-bis-(hydroxyphenyl)-diisopropylbenzenes, as well as their nuclear-alkylated compounds. These and further suitable aromatic dihydroxy compounds are described, for example, in U.S. Pat. Nos. 5,105,004; 5,126,428; 5,109,076; 5,104,723; 5,086,157; 3,028,356; 2,999,835; 3,148,172; 2,991,273; 3,271,367; and 2,999,846, all of which are incorporated herein by reference.

Further examples of suitable bisphenols are 2,2-bis-(4-hydroxy-phenyl)-propane (bisphenol A), 2,4-bis-(4-hydroxyphenyl)-2-methyl-butane, 1,1-bis-(4-hydroxyphenyl)-cyclohexane, α,α′-bis-(4-hydroxyphenyl)-p-diisopropylbenzene, 2,2-bis-(3-methyl-4-hydroxyphenyl)-propane, 2,2-bis-(3-chloro-4-hydroxyphenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfide, bis-(3,5-dimethyl-4-hydroxy-phenyl)-sulfoxide, bis-(3,5-dimethyl-4-hydroxyphenyl)-sulfone, dihydroxy-benzophenone, 2,4-bis-(3,5-dimethyl-4-hydroxyphenyl)-cyclohexane, α,α′-bis-(3,5-dimethyl-4-hydroxyphenyl)-p-diisopropyl-benzene, 1,1-bis-(4-hydroxy-phenyl)-3,3,5-trimethylcyclohexane, 4,4′-dihydroxydiphenyl, and 4,4-sulfonyl diphenol. Examples of particularly preferred bisphenols are 2,2-bis-(4-hydroxyphenyl)-propane, 2,2-bis-(3,5-dimethyl-4-hydroxyphenyl)-propane; 1,1-bis-(4-hydroxyphenyl)-cyclohexane and 4,4′-dihydroxydiphenyl. The most preferred bisphenol is 2,2-bis-(4-hydroxyphenyl)-propane (bisphenol A).

The polycarbonates of the invention may entail in their structure units derived from one or more aromatic dihydroxy compounds.

The polycarbonates of the invention may also be branched by condensing therein small quantities, e.g., 0.05 to 2.0 mol % (relative to the bisphenols) of polyhydroxyl compounds as branching agents. Such branching agents suitable in the context of polycarbonate are known and include the agents disclosed in U.S. Pat. Nos. 4,185,009; 5,367,044; 6,528,612; and 6,613,869 which are incorporated herein by reference, preferred branching agents include isatin biscresol and 1,1,1-tris-(4-hydroxyphenyl)ethane (THPE).

Polycarbonates of this type have been described, for example, in German Offenlegungsschriften 1,570,533; 2,116,974; and 2,113,374; British Patents 885,442; 1,079,821; and U.S. Pat. No, 3,544,514. The following are some examples of polyhydroxyl compounds which may be used the this purpose: phloroglucinol; 4,6-dimethyl-2,4,6-tri-(4-hydroxy-phenyl)-heptane; 1,3,5-tri-(4-hydroxyphenyl)-benzene; 1,1,1-tri-(4-hydroxyphenyl)-ethane; tri-(4-hydroxyphenyl)-phenylmethane; 2,2-bis-[4,4-(4,4′-dihydroxydiphenyl)]-cyclohexyl-propane; 2,4-bis-(4-hydroxy-1-isopropylidene)-phenol; 2,6-bis-(2′-dihydroxy-5′-methylbenzyl)-4-methyl-phenol; 2,4-dihydroxybenzoic acid; 2-(4-hydroxyphenyl)-2-(2,4-dihydroxy-phenyl)-propane and 1,4-bis-(4,4′-dihydroxytriphenylmethyl)-benzene. Some of the other polyfunctional compounds are 2,4-dihydroxy-benzoic acid, trimesic acid, cyanuric chloride and 3,3-bis-(4-hydroxyphenyl)-2-oxo-2,3-dihydroindole.

In addition to the polycondensation process mentioned above, other processes for the preparation of the polycarbonates of the invention are polycondensation in a homogeneous phase and transesterification. The suitable processes are disclosed in U.S. Pat. Nos. 3,028,365; 2,999,846; 3,153,008; and 2,991,273 all of which are incorporated herein by reference.

The preferred process for the preparation of polycarbonates is the interfacial polycondensation process. Other methods of synthesis in forming the polycarbonates of the invention, such as disclosed in U.S. Pat. No. 3,912,688, incorporated herein by reference, may be used.

Suitable polycarbonate resins are available in commerce, for instance, under the MAKROLON trademark from Bayer MaterialScience.

### B. Thermoplastic Polyester

Various polyesters can be used as the thermoplastic polyester in this invention, but thermoplastic polyesters are obtained by polymerizing bifunctional carboxylic acids and diol ingredients are particularly preferred.

Aromatic dicarboxylic acids, for example, terephthalic acid, isophthalic acid, naphthalene dicarboxylic acid and the like, can be used as these bifunctional carboxylic acids, and mixtures of these can be used as needed. Among these, terephthalic acid is particularly preferred from the standpoint of cost. Also, to the extent that the effects of this invention are not lost, other bifunctional carboxylic acids such as aliphatic dicarboxylic acids such as oxalic acid, malonic acid, adipic acid, suberic acid, azelaic acid, sebacic acid, decane dicarboxylic acid, and cyclohexane dicarboxylic acid; and their ester-modified derivatives can also be used.

As diol ingredients, the commonly used ones can be used without difficulty, for example, straight chain aliphatic and cycloaliphatic diols having 2 to 15 carbon atoms, for example, ethylene glycol, propylene glycol, 1,4-butanediol, trimethylene glycol, tetramethylene glycol, neopentyl glycol, diethylene glycol, cyclohexane dimethanol, heptane-1,7-diol, octane-1,8-diol, neopentyl glycol, decane-1,10-diol, etc.; polyethylene glycol; bivalent phenols such as dihydroxydiarylalkanes such as 2,2-bis(4-hydroxyphenyl)propane that can be called bisphenol-A, bis(4-hydroxyphenyl)methane, bis(4-hydroxyphenyl)naphthylmethane, bis(4-hydroxyphenyl)phenylmethane, bis(4-hydroxyphenyl)-(4-isopropylphenyl)methane, bis(3,5-dichloro-4-hydroxyphenyl)methane, bis(3,5-dimethyl-4-hydroxyphenyl)methane, 1,1 -bis(4-hydroxyphenyl)ethane, 1-naphthyl-1,1-bis(4-hydroxyphenyl)ethane, 1-phenyl-1,1-bis(4-hydroxyphenyl)ethane, 1,2-bis(4-hydroxyphenyl)ethane, 2-methyl-1,1-bis(4-hydroxyphenyl)propane, 2,2-bis(3,5-dimethyl-4-hydroxyphenyl)propane, 1-ethyl-1,1-bis(4-hydroxyphenyl)propane, 2,2-bis(3,5-dichloro-4-hydroxyphenyl)propane, 2,2-bis(3,5-dibromo-4-hydroxyphenyl)propane, 2,2-bis(3 -chloro-4-hydroxyphenyl)propane, 2,2-bis(3-methyl-4-hydroxyphenyl)propane, 2,2-bis(3-fluoro-4-hydroxyphenyl)propane, 1,1-bis(4-hydroxyphenyl)butane, 2,2-bis(4-hydroxyphenyl)butane, 1,4-bis(4-hydroxyphenyl)butane, 2,2-bis(4-hydroxyphenyl)pentane, 4-methyl-2,2-bis(4-hydroxyphenyl)pentane, 2,2-bis(4-hydroxyphenyl)hexane, 4,4-bis(4-hydroxyphenyl)heptane, 2,2-bis(4-hydroxyphenyl)nonane, 1,10-bis(4-hydroxyphenyl)decane, 1,1-bis(4-hydroxyphenyl)-3,3,5-trimethylcyclohexane, and 2,2-bis(4-hydroxyphenyl)-1,1,1,3,3,3-hexafluoropropane; dihydroxydiarylcycloalkanes such as 1,1-bis(4-hydroxyphenyl)cyclohexane, 1,1-bis(3,5-dichloro-4-hydroxyphenyl)cyclohexane, and 1,1-bis(4-hydroxyphenyl)cyclodecane; dihydroxydiarylsulfones such as bis(4-hydroxyphenyl)sulfone, and bis(3,5-dimethyl-4-hydroxyphenyl)sulfone, bis(3-chloro-4-hydroxyphenyl)sulfone; dihydroxydiarylethers such as bis(4-hydroxyphenyl)ether, and bis(3-5-dimethyl-4-hydroxyphenyl)ether; dihydroxydiaryl ketones such as 4,4′-dihydroxybenzophenone, and 3,3′,5,5′-tetramethyl-4,4-dihydroxybenzophenone; dihydroxydiaryl sulfides such as bis(4-hydroxyphenyl)sulfide, bis(3-methyl-4-hydroxyphenyl)sulfide, and bis(3,5-dimethyl-4-hydroxyphenyl)sulfide; dihydroxydiaryl sulfoxides such as bis(4-hydroxyphenyl)sulfoxide; dihydroxydiphenyls such as 4,4′-dihydroxyphenyl; dihydroxyarylfluorenes such as 9,9-bis(4-hydroxyphenyl)fluorene; dihydroxybenzenes such as hydroxyquinone, resorcinol, and methylhydroxyquinone; and dihydroxynaphthalenes such as 1,5-dihydroxynaphthalene and 2,6-dihydroxynaphthalene. Also, two or more types of diols can be combined as needed.

In a specific embodiment, the polyester is polyethylene terephthalate, polybutylene terephthalate, polyethylene naphthalate, polybutylene naphthalate, polytrimethylene terephthalate, poly(1,4-cyclohexylenedimethylene 1,4-cyclohexanedicarboxylate), poly(1,4-cyclohexylenedimethylene terephthalate), poly(cyclohexylenedimethylene-co-ethylene terephthalate), or a combination comprising at least one of the foregoing polyesters. Polytrimethylene terephthalate (PTT) is particularly suitable as the polyester in the invention.

Thermoplastic polyesters can be produced in the presence or absence of common polymerization catalysts represented by titanium, germanium, antimony or the like; and can be produced by interfacial polymerization, melt polymerization or the like.

The molecular weight of the thermoplastic polyesters that can be used in this invention is not limited as long as the properties of the molded items are not lost, and need to be optimized according to the kinds of thermoplastic polyesters that are used. However, weight average molecular weights, as measured by GPC and calculated as polystyrene, are preferably 10,000 to 200,000, with 20,000 to 150,000 being particularly suitable. If the weight average molecular weight is within the above range, the mechanical characteristics of the molded items when molded are good, and the mold ability is excellent. If thermoplastic polyesters that have a weight average molecular weight less than 10,000 are used, the mechanical properties themselves of the resins are unsatisfactory. For example, the mechanical characteristics of the molded items are unsatisfactory. On the other hand, if the weight average molecular weight is greater than 200,000, the moldability decreases, for example, the melt viscosity during molding increases.

### C. Graft (Co)Polymer

The graft (co)polymer suitable in the context of the invention has core/shell structure. It may be obtained by graft polymerizing alkyl(meth)acrylate and optionally a copolymerizable vinyl monomer onto a composite rubber core. The composite rubber core that includes interpenetrated and inseparable interpenetrating network (IPN) type polymer is characterized in that its glass transition temperature is below 0° C., preferably below −20° C., especially below −40° C. The amount of component C present in the inventive composition is 1 to 20, advantageously 2 to 15, preferably 5 to 12, most preferably 7 to 10 phr.

The preferred core is polysiloxane-alkyl(meth)acrylate interpenetrating network (IPN) type polymer that contains polysiloxane and butylacrylate. The shell is a rigid phase, preferably polymerized of methylmethacrylate. The weight ratio of polysiloxane/alkyl(meth)acrylate/rigid shell is 70-90/5-15/5-15, preferably 75-85/7-12/7-12, most preferably 80/10/10.

The rubber core has median particle size (d₅₀ value) of 0.05 to 5, preferably 0.1 to 2 microns, especially 0.1 to 1 micron. The median value may be determined by ultracentrifuge measurement (W. Scholtan, H. Lange, Kolloid, Z. und Z. Polymere 250 (1972) 782-1796).

The polyorganosiloxane component in the silicone acrylate composite rubber may be prepared by reacting an organosiloxane and a multifunctional crosslinker in an emulsion polymerization process. It is also possible to insert graft-active sites into the rubber by addition of suitable unsaturated organosiloxanes.

The organosiloxane is generally cyclic, the ring structures preferably containing from 3 to 6 Si atoms. Examples include hexamethylcyclotrisiloxane, octamethylcyclotetrasiloxane, decamethylcyclopentasiloxane, dodecamethylcyclohexasiloxane, trimethyltriphenylcyclotrisiloxane, tetramethyltetraphenylcyclotetrasiloxane, octaphenylcyclotetrasiloxane, which may be used alone or in a mixture of 2 or more such compounds. The organosiloxane component is present in the silicone acrylate rubber in an amount of at least 70%, preferably at least 75%, based on weight of the silicone acrylate rubber.

Suitable crosslinking agents are tri- or tetra-functional silane compounds. Preferred examples include trimethoxymethylsilane, triethoxyphenylsilane, tetramethoxysilane, tetraethoxysilane, tetra-n-propoxysilane, tetrabutoxysilane.

Graft-active sites may be included into the polyorganosiloxane component of the silicone acrylate rubber by incorporating a compound conforming to any of the following structures:

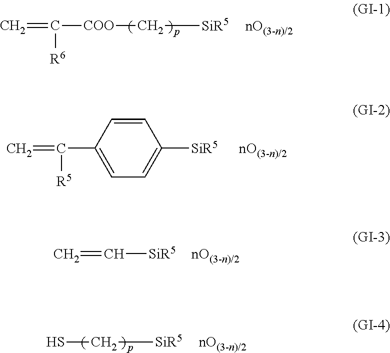

wherein,
R⁵ denotes methyl, ethyl, propyl or phenyl,
R⁶ denotes hydrogen or methyl,
n denotes 0, 1 or 2, and
p denotes 1 to 6,

(Meth)acryloyloxysilane is a preferred compound for forming the structure (GI-1). Preferred (meth)acryloyloxysilanes include β-methacryloyloxyethyl-dimethoxy-methyl-silane, γ-methacryloyl-oxy-propylmethoxy-dimethyl-silane, γ-methacryloyloxypropyl-dimethoxy-methyl-silane, γ-methacryloyloxypropyl-tri-methoxy-silane, γ-methacryloyloxy-propyl-ethoxy-diethyl-silane, γ-methacryloyl-oxypropyl-diethoxy-methyl-silane, γ-methacryloyloxy-butyl-diethoxy-methyl-silane.

Vinylsiloxanes, especially tetramethyl-tetravinyl-cyclotetrasiloxane, are suitable for forming the structure GI-2. p-Vinylphenyl-dimethoxy-methylsilane, for example, is suitable for forming structure GI-3. γ-Mercaptopropyldimethoxy-methylsilane, γ-mercaptopropylmethoxy-dimethylsilane, γ-mercaptopropyl-diethoxymethylsilane, etc. are suitable for forming structure (GI-4). The amount of these compounds is from up to 10%, preferably 0.5 to 5.0% (based on the weight of polyorganosiloxone).

The acrylate component in the silicone acrylate composite rubber may be prepared from alkyl(meth)acrylates, crosslinkers and graft-active monomer units. Examples of preferred alkyl(meth)acrylates include alkyl acrylates, such as methyl acrylate, ethyl acrylate, n-propyl acrylate, n-butyl acrylate, 2-ethylhexyl acrylate, and alkyl methacrylates, such as hexyl methacrylate, 2-ethylhexyl methacrylate, n-lauryl methacrylate, n-butyl acrylate is particularly preferred.

Multifunctional compounds may be used as crosslinkers. Examples include ethylene glycol dimethacrylate, propylene glycol dimethacrylate, 1,3-butylene glycol dimethacrylate and 1,4-butylene glycol dimethacrylate.

The following compounds individually or in mixtures may be used for inserting graft-active sites: ally methacrylate, triallyl cyanurate, triallyl isocyanurate, ally methacrylate. Ally methacrylate may also act as crosslinker. These compounds may be used in amounts of 0.1 to 20%, based on the weight of acrylate rubber component.

Methods of producing the silicone acrylate composite rubbers which are preferably used in the compositions according to the invention, and their grafting with monomers, are described, for example, in U.S. Pat. Nos. 4,888,388 and 4,963,619 both incorporated herein by reference.

The graft polymerization onto the graft base (herein C.1) may be carried out in suspension, dispersion or emulsion. Continuous or discontinuous emulsion polymerization is preferred. The graft polymerization is carried out with free-radical initiators (e.g. peroxides, azo compounds, hydroperoxides, persulfates, perphosphates) and optionally using anionic emulsifiers, e.g. carboxonium salts, sulfonic acid salts or organic sulfates.

The grail shell (C.2) may be formed of a mixture of
C.2.1 0 to 80%, preferably 0 to 50%, more preferably 0 to 25% (based on the weight of the graft shell), of vinyl aromatic compounds or ring-substituted vinyl aromatic compounds (e.g. styrene, α-methylstyrene, p-methylstyrene), vinyl cyanides (e.g. acrylonitrile and methacrylonitrile), and
C.2.2 100 to 20%, preferably 100 to 50%, more preferably 100 to 75% (based on the weight of the graft shell) of at least one monomer selected from the group consisting of (meth)acrylic acid (C₁-C₈)-alkyl esters (e.g. methyl methacrylate, n-butyl acrylate, tert.-butyl acrylate) and derivatives (e.g. anhydrides and imides) of unsaturated carboxylic acids (e.g. maleic anhydride and N-phenyl maleimide).

The preferred graft shell includes one or more (meth)acrylic acid (C₁-C₈)-alkyl esters, especially methyl methacrylate. A particularly suitable graft (co)polymer is available from Mitsubishi Rayon Co., Ltd. as Metablen SX-005.

### D. Polylactic Acid Polymer

The polylactic acid polymer suitable in the context of this invention refers to a melt processable polymer based on D and/or L lactic acid preferably having molecular weight lower than 1,000,000, more preferably lower than 150,000 and most preferably from 50,000 to 110,000, its melt flow rate is preferably 1 to 200, more preferably 2 to 50, most preferably 3 to about 20 g/10 minutes, as determined according to ASTM D1238-E (210° C./2.16 kg). Polylactic acid characteristically has a glass transition temperature around 59° C. and a melting point of 178° C.

### E. Other Components

The inventive composition may further include additives that are known for their function in the context of thermoplastic molding compositions that contain poly(ester)carbonates. These include any one or more of lubricants, mold release agents, for example pentaerythritol tetrastearate, nucleating agents, antistatic agents, thermal stabilizers, light stabilizers, hydrolytical stabilizers, fillers and reinforcing agents, colorants or pigments, as well as further flame retarding agents or a flame retarding synergists.

The inventive compositions may be prepared conventionally using conventional equipment and following conventional procedures.

The inventive composition may be used to produce moldings of any kind by thermoplastic processes such as injection molding, extrusion and blow molding methods.

### EXAMPLES

The present invention is further illustrated, but is not to be limited, by the following examples. All quantities given in “parts” and “percents” are understood to be by weight, unless otherwise indicated. In preparing the compositions described below the following components were used in the amounts as given in Table I:

| | |
|---|---|
| PC | a bisphenol-A based homopolycarbonate having |
| | melt flow rate of about 4 g/10 min (at 300° C., |
| | 1.2 Kg) per ASTM D 1238, commercially available |
| | from Bayer MaterialScience as MAKROLON 3208; |
| PTT | polytrimethylene terephthalate, commercially |
| | available from Shell as CORTERRA polymer 200; |
| ELASTOMER A | methyl methacrylate (MMA) -grafted siloxane(Si)- |
| | butyl acrylate (BA)composite rubber containing |
| | MMA shell and Si-BA in the core. The weight ratio |
| | of Si/BA/MMA is 80/10/10; |
| ELASTOMER B | methyl methacrylate (MMA) - grafted siloxane(Si)- |
| | butyl acrylate (BA)composite rubber containing |
| | MMA shell and Si-BA in the core. The weight ratio |
| | of Si/BA/MMA is 10/80/10; |
| ZINC BORATE | having an average particle diameter of 5 microns, |
| | commercially available from Chemtura as ZB-467; |
| FLAME | bisphenol diphosphate phenyl ester, commercially |
| RETARDANT A | available from Chemtura as REOFOS BAPP; |
| FLAME | encapsulated polytetrafluoroethylene (PTFE) with |
| RETARDANT B | styrene acrylonitrile (SAN), commercially available |
| | from Chemtura as BLENDEX 449; and |
| PLA | polylactic acid. |

In the preparation of exemplified compositions, the components and additives were melt compounded in a twin screw extruder ZSK 30 at a temperature profile from 120 to 255° C. The pellets obtained were dried in a forced air convection oven at 120° C., for 4 to 6 hours. The parts were injection molded (melt temperature 265 to 285° C., mold temperature about 75° C.).

TABLE I

| | Ex. 1 | Ex. 2 | Ex. 3 | Ex. 4 |
|---|---|---|---|---|
| PC | 60 | 60 | 60 | 60 |
| PTT | 10 | 10 | 10 | 10 |
| ELASTOMER A | | | 10 | 10 |
| ELASTOMER B | 10 | 10 | | |
| FLAME RETARDANT A | 10 | 10 | 10 | 10 |
| FLAME RETARDANT B | 0.5 | 0.5 | 0.5 | 0.5 |
| ZINC BORATE | | 2.5 | | 2.5 |
| PLA | 12 | 12 | 12 | 12 |

The notched impact strength (NI) at the indicated temperature was determined in accordance with ASTM D-256 using specimens ⅛″ in thickness. The flammability rating was determined according to UL-94 V on specimens having the indicated thickness. The melt flow rates (MVR) of the compositions were determined in accordance with ASTM D-1238 at 265° C., 5 Kg load.

ASTM Test Method E-84 (Steiner tunnel test) measures how far and fast flames spread across the surface of the test sample and how much smoke is generated. FSR is expressed as a number on a continuous scale where inorganic reinforced cement board is 0 and red oak is 100. The most common classifications are: Class I, also called A, with a 0-25 FSR; Class II or B with a 26-75 FSR; and Class III or C with a 76-200 FSR. A smoke-developed index not to exceed 450 is required by IBC section 803.1 for interior wall and ceiling finishes.

TABLE II

| Test | Ex. 1 | Ex. 2 | Ex. 3 | Ex. 4 |
|---|---|---|---|---|
| Mini-tunnel-amount of | 445 | 500 | 284 | 469 |
| smoke generated (2 mm) | | | | |
| Mini-tunnel-flame spread | 21 | 22 | 16 | 21 |
| index of 48 inch tunnel | | | | |
| (2 mm) | | | | |
| MVR (cm³/10 min) | 26.98 | 28.4 | 29.75 | 37.62 |
| NI @−23° C. | 5.864 | 2.032 | 13.904 | 2.36 |
| (ft · lbf/in) | | | | |
| NI @23° C. | 17.456 | 15.43 | 16.316 | 10.706 |
| (ft · lbf/in) | | | | |
| UL-94 (2 mm) | Failed | Failed | UL94-V1 | UL94-V1 |

As can be appreciated by reference to Tables I and II, the compositions of Example 1 and 3 are identical except that of Example 3 also contained Elastomer 2. The composition of Example 3 had a UL-94 rating of V1, whereas Example 1 failed the UL-94 test. Similarly, the compositions of Examples 2 and 4 were identical except that of Example 4 also contained Elastomer 2. The composition of Example 4 had a UL-94 rating of V1, whereas Example 2 failed the UL-94 test.

Surprisingly, it has been found that zinc borate, typically used as a smoke suppressant, instead increased smoke generation in the compositions as can be appreciated by comparing Examples 1 to 2, and Examples 3 to 4.

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

Various aspects of the subject matter described herein are set out in the following numbered clauses:

1. A thermoplastic molding composition comprising: A) 50 to 98 parts by weight (pbw) aromatic poly(ester)carbonate having a weight-average molecular weight of at least 25,000; B) 1 to 30 parts by weight of thermoplastic polyester; C) 1 to 20 parts per hundred parts resin (phr) of graft (co)polymer having a core-shell morphology, including a grafted shell that contains polymerized alkyl(meth)acrylate and a composite rubber core that contains interpenetrated and inseparable polyorganosiloxane and poly(meth)alkyl acrylate components, wherein said core is in the form of particles having median particle size of 0.05 to 5 microns and glass transition temperature below 0° C., and wherein weight ratio of polyorganosiloxane/poly(meth)alkylacrylate/rigid shell is 70-90/5-15/5-15; and D) 1 to 30 parts by weight of polylactic acid.

2. The composition according to clause 1, wherein the aromatic poly(ester)carbonate is a homopolycarbonate based on bisphenol A.

3. The composition according to clause 1, wherein said B) is polytrimethylene terephthalate.

4. The composition of clause 1, wherein alkyl(meth)acrylate butylacrylate.

5. The composition of clause 1, wherein the weight ratio in said C) is 75-85/7-12/7-12.

6. The composition of clause 1, wherein the weight ratio is in said C) is 80/10/10.

7. The composition of clause 1, wherein the median particle size of said C) is 0.1 to 2 microns.

8. The composition according to clause 1, wherein said boron compound is zinc borate.

9. The composition according to clause 1 further containing at least one member selected from the group consisting of lubricant, mold release agent, nucleating agent, antistatic, thermal stabilizer, hydrolytical stabilizer, light stabilizer, colorant, pigment, filter, reinforcing agent, flameproofing agent other than component E), and flameproofing synergist.

What is claimed is:

1. A thermoplastic molding composition comprising:
A) 50 to 98 parts by weight (pbw) aromatic poly(ester)carbonate having a weight-average molecular weight of at least 25,000;
B) 1 to 30 parts by weight of thermoplastic polyester;
C) 1 to 20 parts per hundred parts resin (phr) of graft (co)polymer having a core-shell morphology, including a grafted shell that contains polymerized alkyl(meth)acrylate and a composite rubber core that contains interpenetrated and inseparable polyorganosiloxane and poly(meth)alkyl acrylate components, wherein said core is in the form of particles having median particle size of 0.05 to 5 microns and glass transition temperature below 0° C., and wherein weight ratio of polyorganosiloxane/poly(meth)alkylacrylate/rigid shell is 70-90/5-15/5-15; and
D) 1 to 30 parts by weight of polylactic acid.

2. The composition according to claim 1, wherein the aromatic poly(ester)carbonate is a homopolycarbonate based on bisphenol A.

3. The composition according to claim 1, wherein said B) is polytrimethylene terephthalate.

4. The composition of claim 1, wherein alkyl(meth)acrylate is butylacrylate.

5. The composition of claim 1, wherein the weight ratio in said C) is 75-85/7-12/7-12.

6. The composition of claim 1, wherein the weight ratio is in said C) is 80/10/10.

7. The composition of claim 1, wherein the median particle size of said C) is 0.1 to 2 microns.

8. The composition according to claim 1, wherein said boron compound is zinc borate.

9. The composition according to claim 1 further containing at least one member selected from the group consisting of lubricant, mold-release agent, nucleating agent, antistatic, thermal stabilizer, hydrolytical stabilizer, light stabilizer, colorant, pigment, filler, reinforcing agent, flameproofing agent other than component E), and flameproofing synergist.
